(19) United States
(12) Patent Application Publication
(10) Pub. No.: US 2025/0124512 A1
(43) Pub. Date: Apr. 17, 2025

(54) ENTERPRISE RISK RELATIONSHIP DOCUMENT SERVER

(71) Applicants: Jonathan David Humpherys, Weatogue, CT (US); Riya Patel, Terryville, CT (US); Emma C. Walker, West Winfield, NY (US); Kathy Betts, Huntersville, NC (US); Anna Alexis Kirkman, Mint Hill, NC (US); Ramcharan Rayala, Concord, NC (US)

(72) Inventors: Jonathan David Humpherys, Weatogue, CT (US); Riya Patel, Terryville, CT (US); Emma C. Walker, West Winfield, NY (US); Kathy Betts, Huntersville, NC (US); Anna Alexis Kirkman, Mint Hill, NC (US); Ramcharan Rayala, Concord, NC (US)

(21) Appl. No.: 18/485,039

(22) Filed: Oct. 11, 2023

(51) Int. Cl. G06Q 40/08

(52) U.S. Cl. CPC G06Q 40/08

(57) ABSTRACT

An enterprise risk relationship document back-end application computer server receives a risk relationship document request associated with a particular risk relationship identifier. Responsive to the risk relationship document request, the computer server retrieves information from a risk relationship data store. The risk relationship data store may, for example, contain electronic records for a plurality of risk relationships between the enterprise and parties, and, for each risk relationship, a risk relationship identifier, a party identifier, a communication address, and at least one risk relationship parameter. Based on the retrieved information, a risk relationship document may be automatically created. The computer server may automatically establish a communication link and transmit information about the risk relationship document to the communication address associated with the particular risk relationship identifier. The computer server may also exchange data with a remote device to support interactive user interface displays that include information about the risk relationship document.

### TECHNICAL FIELD

The present application generally relates to computer systems and more particularly to computer systems that are adapted to accurately, securely, and/or automatically manage risk relationship document requests for a risk relationship enterprise.

### BACKGROUND

An enterprise, such as an insurer, may enter into risk relationships with various parties (e.g., people or businesses). A Certificate Of Insurance (“COI”) document created by an enterprise serves as proof of insurance and summarizes a particular risk relationship's coverages. For example, clients of a small business owner may require a COI before accepting a job (knowing that if something happens, the small business owner has adequate insurance coverage). Certificates can be sent one time or at every renewal of an insurance policy (and may be specific to a recipient). Note that COIs might be sent directly to a recipient via email, fax, or postal mail or to an insured or insurance agent or agency for delivery.

Manually creating these type documents in response to requests can be a time consuming and difficult task, especially when a substantial number of requests are received by an enterprise. Moreover, customers and agents may be unable to see a list of existing recipients which can cause duplicates certificates to be requested and delivered (e.g., at each renewal). In addition, agents may find it difficult to delete duplicates, delete parties with ended relationships, change terms, etc. and trying to figure out what COI's have been previously requested may be time consuming.

It would be desirable to provide improved systems and methods to accurately and/or automatically provide risk relationship document tools for an enterprise. Moreover, the results should be easy to access, understand, interpret, update, etc.

### SUMMARY OF THE INVENTION

According to some embodiments, systems, methods, apparatus, computer program code and means are provided to accurately and/or automatically provide enterprise risk relationship document office tools for an enterprise in a way that provides fast, secure, and useful results and that allows for flexibility and effectiveness when responding to those results.

Some embodiments are directed to an enterprise risk relationship document system implemented via a back-end application computer server. The computer server receives a risk relationship document request associated with a particular risk relationship identifier. Responsive to the risk relationship document request, the computer server retrieves information from a risk relationship data store. The risk relationship data store may, for example, contain electronic records for a plurality of risk relationships between the enterprise and parties, and, for each risk relationship, a risk relationship identifier, a party identifier, a communication address, and at least one risk relationship parameter. Based on the retrieved information, a risk relationship document may be automatically created. The computer server may automatically establish a communication link and transmit information about the risk relationship document to the communication address associated with the particular risk relationship identifier. The computer server may also exchange data with a remote device to support interactive user interface displays that include information about the risk relationship document.

Some embodiments comprise: means for receiving, at a computer processor of the back-end application computer server, a risk relationship document request associated with a particular risk relationship identifier; responsive to the risk relationship document request, means for retrieving information from a risk relationship data store, wherein the risk relationship data store contains electronic records associated with a plurality of risk relationships between the enterprise and parties, and, for each risk relationship, a risk relationship identifier, a party identifier, a communication address, and at least one risk relationship parameter; based on the retrieved information, means for automatically creating a risk relationship document; means automatically establishing a communication link and transmitting information about the risk relationship document to the communication address associated with the particular risk relationship identifier; and means for exchanging data with a remote device via a distributed communication network to support interactive user interface displays that include information about the risk relationship document.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is improved and computerized enterprise risk relationship document interactions for an enterprise that provides fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 shows relationships between various entities according to some embodiments.

FIG. 2 is a high-level block diagram of an enterprise risk relationship document system in accordance with some embodiments.

FIG. 3 illustrates a high-level enterprise risk relationship document method according to some embodiments.

FIG. 4 is a risk relationship document request display in accordance with some embodiments.

FIG. 5 is a list of prior certificate holders display according to some embodiments.

FIG. 6 is a search result display in accordance with some embodiments.

FIG. 7 is a supplemental information display according to some embodiments.

FIG. 8 is a document delivery details display in accordance with some embodiments.

FIG. 9 is a certificate holder removal display according to some embodiments.

FIG. 10 is a certificate transmission display in accordance with some embodiments.

FIG. 11 is a transmission confirmation display according to some embodiments.

FIG. 12 is an insurance agency display in accordance with some embodiments.

FIG. 13 is another certificate holders display according to some embodiments.

FIG. 14 is a more detailed system according to some embodiments.

FIG. 15 is a block diagram of an apparatus in accordance with some embodiments.

FIG. 16 is a portion of a tabular security request database according to some embodiments.

FIG. 17 is an operator or administrator display in accordance with some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with enterprise risk relationship documents. The present invention is directed to more than merely a computer implementation of a routine or conventional activity previously known in the industry as it provides a specific advancement in the area of electronic record analysis by providing improvements in the operation of a computer system that customizes enterprise risk relationship documents (including those associated with risk relationships). The present invention provides improvement beyond a mere generic computer implementation as it involves the novel ordered combination of system elements and processes to provide improvements in the speed, security, and accuracy of such an enterprise risk relationship document tool for an enterprise. Some embodiments of the present invention are directed to a system adapted to automatically customize and execute enterprise risk relationship documents, aggregate data from multiple data sources, automatically generate risk relationship document information to reduce unnecessary messages or communications, etc. (e.g., to consolidate communications between parties). Moreover, communication links and messages may be automatically established, aggregated, formatted, modified, removed, exchanged, etc. to improve network performance (e.g., by reducing an amount of network messaging bandwidth and/or storage required to create enterprise risk relationship document messages or alerts, improve security, reduce the size of data stores, more efficiently collect, present, and utilize risk relationship document information, etc.).

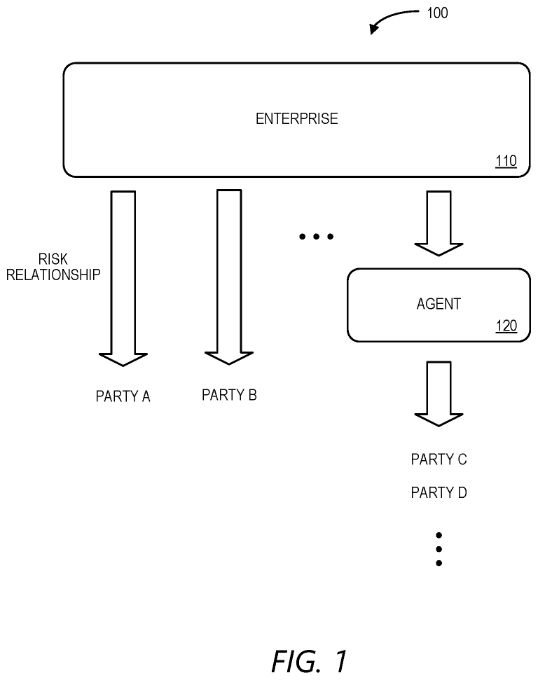

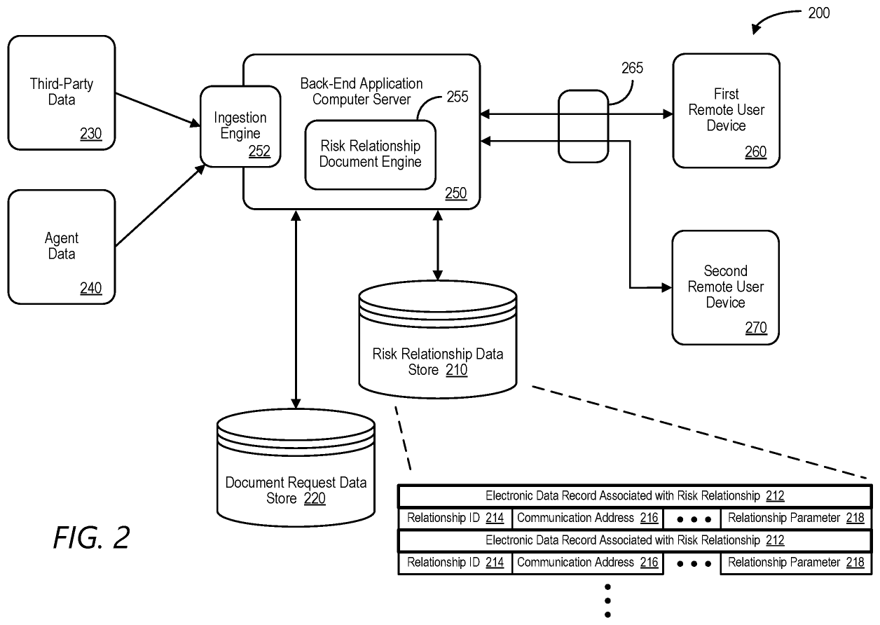

FIG. 1 shows relationships 100 between various entities according to some embodiments. An enterprise 110 may establish risk relationships (e.g., associated with insurance policies) directly with parties (e.g., parties A and B in FIG. 1), such as people and businesses. In some cases, an insurance agent or agency 120 may act as a go-between the enterprise 110 and various parties (e.g., parties C and D in FIG. 1). FIG. 2 is a high-level block diagram of an enterprise risk relationship document system 200 that may be provided according to some embodiments of the present invention. In particular, the system 200 includes a back-end application computer server 250 that may access information in a risk relationship data store 210 (e.g., storing a set of electronic records associated with various risk relationships 212, each record including, for example, one or more relationship identifiers 214, communication addresses 216, relationship parameters 218, etc.). The back-end application computer server 250 may also store information into other data stores, such as a document request data store 220, and utilize an ingestion engine 252 and a risk relationship document engine 255 to exchange and process messages and view, analyze, and/or update the electronic records. The back-end application computer server 250 may also exchange information with a first remote user device 260 and a second remote user device 270 (e.g., via a firewall 265). According to some embodiments, an interactive graphical user interface platform of the back-end application computer server 250 may facilitate the creation and review of enterprise risk relationship documents, recommendations, alerts, and/or the display of results via one or more remote administrator computers (e.g., to summarize system 200 performance) and/or the remote user devices 260, 270. For example, the first remote user device 260 may transmit annotated and/or updated information to the back-end application computer server 250. Based on the updated information, the back-end application computer server 250 may adjust data in the risk relationship data store 210 and/or the document request data store 220 and the change may (or may not) be used in connection with the second remote user device 270. Note that the back-end application computer server 250 and/or any of the other devices and methods described herein might be associated with a third party, such as a vendor that performs a service for an enterprise. In some cases, the ingestion engine 252 may receive information from third-parties 230 and/or agents 240.

The back-end application computer server 250 and/or the other elements of the system 200 might be, for example, associated with a Personal Computer (“PC”), laptop computer, smartphone, an enterprise server, a server farm, and/or a database or similar storage devices. According to some embodiments, an “automated” back-end application computer server 250 (and/or other elements of the system 200) may facilitate the automated access and/or update of electronic records in the data stores 210, 220 and/or the management of document requests. As used herein, the term “automated” may refer to, for example, actions that can be performed with little (or no) intervention by a human.

Devices, including those associated with the back-end application computer server 250 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 250 may store information into and/or retrieve information from the risk relationship data store 210 and/or the document request data store 220. The data stores 210, 220 may be locally stored or reside remote from the back-end application computer server 250. As will be described further below, the risk relationship data store 210 may be used by the back-end application computer server 250 in connection with an interactive user interface to access and update electronic records. Although a single back-end application computer server 250 is shown in FIG. 2, any number of such devices may be included. Moreover, various devices described herein might be combined according to embodiments of the present invention. For example, in some embodiments, the back-end application computer server 250 and risk relationship data store 210 might be co-located and/or may comprise a single apparatus.

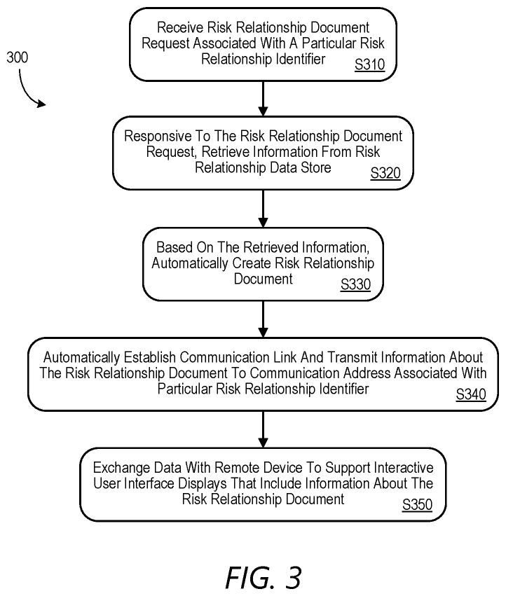

The elements of the system 200 may work together to perform the various embodiments of the present invention. Note that the system 200 of FIG. 2 is provided only as an example, and embodiments may be associated with additional elements or components. According to some embodiments, the elements of the system 200 automatically transmit information associated with an interactive user interface display over a distributed communication network. FIG. 3 illustrates a method 300 that might be performed by some or all of the elements of the system 200 described with respect to FIG. 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a computer processor of the back-end application computer server may receive a risk relationship document request associated with a particular risk relationship identifier. Responsive to the risk relationship document request, the system may retrieve information from a risk relationship data store at S320. The risk relationship data store may, for example, contain electronic records associated with a plurality of risk relationships between the enterprise and parties. For each risk relationship, a record might include a risk relationship identifier, a party identifier, a communication address, and at least one risk relationship parameter. The communication address mighty be associated with, for example an email address, a telephone number, a Quick Response (“QR”) code, a username and password (e.g., to access a web portal), a chat interface, an Interactive Voice Response (“IVR”) system, a mobile smartphone application, etc. As used herein, the phrase “risk relationship parameter” might refer to a producer, a type of insurance, a coverage limit, a policy period, a certificate holder, etc. Moreover, according to some embodiments, the risk relationship document request might be received from an employee of the enterprise, an insured, an insurance agent or agency, etc.

Based on the retrieved information, at S330 the system may automatically create a risk relationship document. The risk relationship document may be associated with, for example, proof of insurance, such as a Certificate Of Insurance (“COI”) showing proof of liability coverage, an Evidence Of Property (“EOP”) showing proof of property coverage, a Statement Of Insurance (“SOI”) providing snapshot view of policy coverages and limits, a state-specific document (e.g., New York form C105.2 which is used in specific scenarios to show proof of workers' compensation coverage), etc.

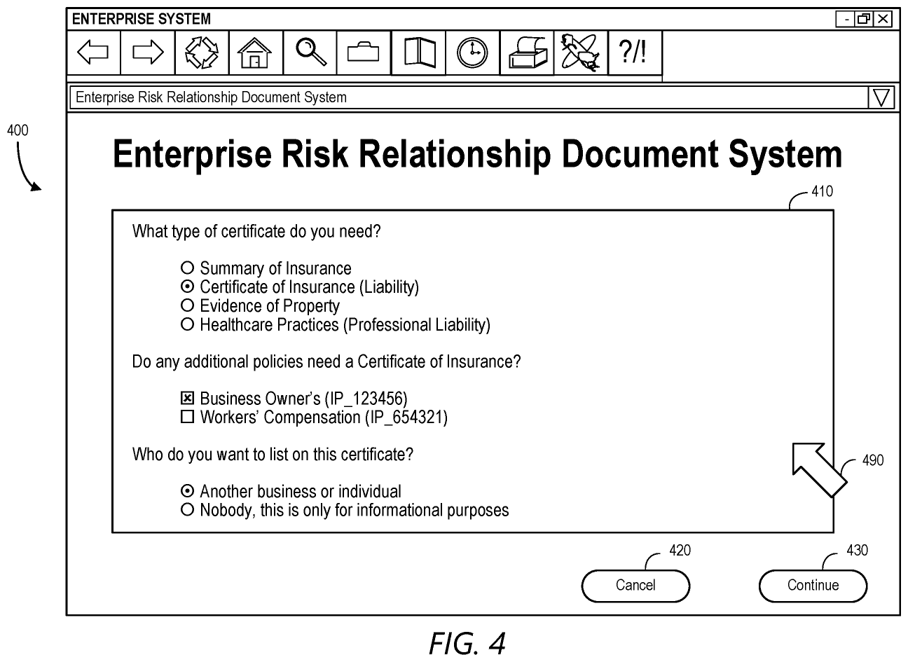

At S340, the system may automatically establish a communication link and transmit information about the risk relationship document to the communication address associated with the particular risk relationship identifier. At S350, the system may exchange data with a remote device (e.g., via a distributed communication network) to support interactive user interface displays that include information about the risk relationship document. Examples of such displays are described herein in connection with FIGS. 4 through 13. According to some embodiments, the interactive user interface displays may further let a requestor reuse information from a prior risk relationship document request, display information about a plurality of insureds, perform a search associated with the plurality of insureds, let a requestor schedule or cancel future risk relationship document requests, etc.

In some embodiments, the enterprise is an insurer, the risk relationships are associated with insurance policies, and the parties are associated with insureds. Moreover, a plurality of risk relationship documents of different types (e.g., a COI and SOI) may be created and transmitted. According to some embodiments, a requestor may store a risk relationship document or related information in a mobile smartphone device (e.g., an APPLE® wallet). Some embodiments may provide an ability to share a certificate via a one-time access code, a QR code, a personalized link, etc.

FIG. 4 is a risk relationship document request display 400 in accordance with some embodiments. The display 400 includes a data entry area 410 where a user can indicate which types of certificates are needs, whether or any additional policies need a certificate, who is listed on a certificate, etc. (e.g., via touchscreen or computer mouse pointer 490). Moreover, the user may be able to select a “Cancel” icon 420 or a “Continue” icon 430 (to save the information in the data entry area 410).

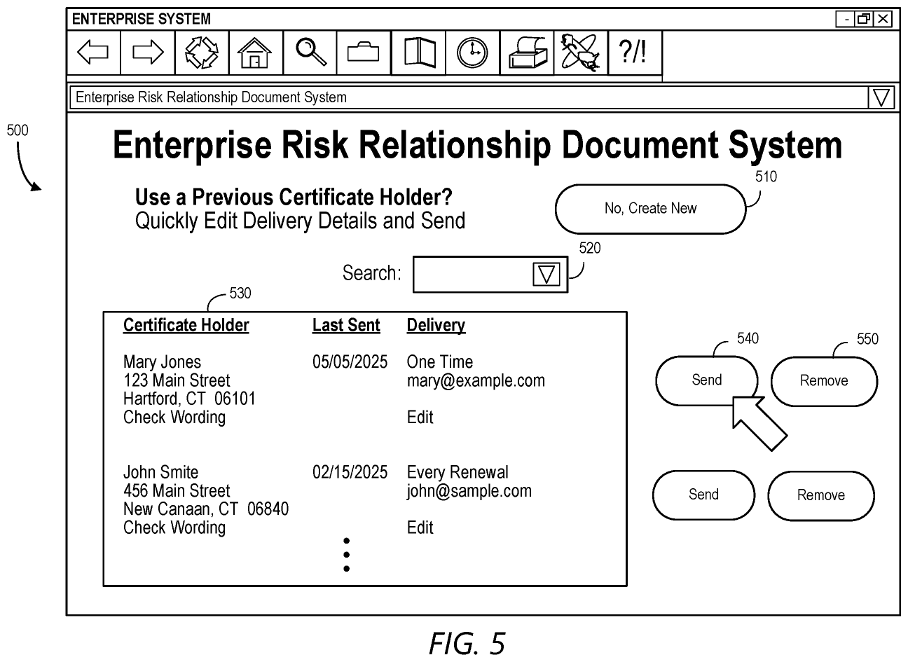

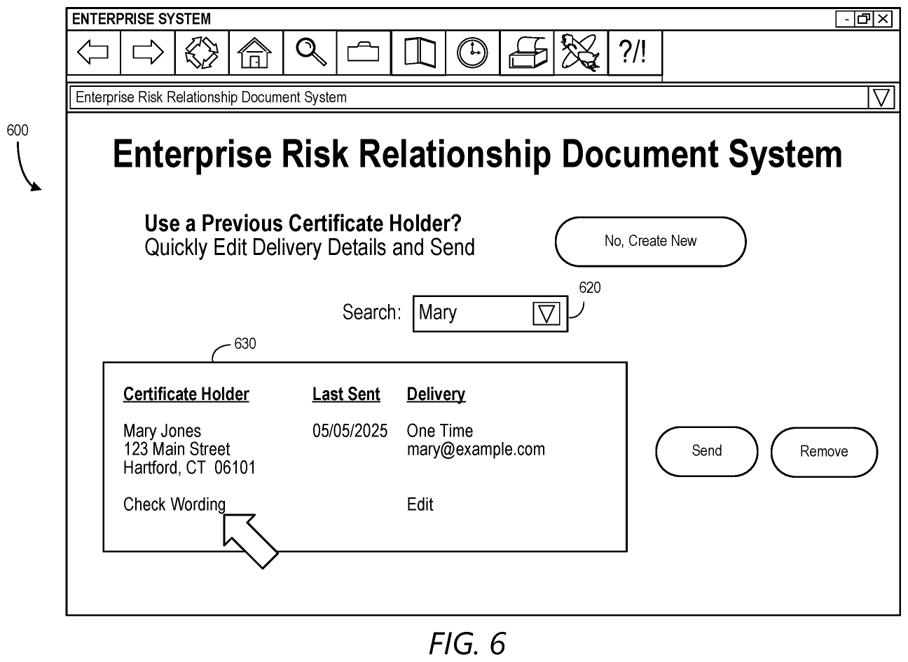

FIG. 5 is a list of prior certificate holders display 500 according to some embodiments. The user may opt to create a new certificate holder 510 instead of selecting a previously requested certificate holder from a list 530 (e.g., after a prior policy renewal). Selecting a previous holder may avoid the need to re-enter various information, such as a communication address, delivery type, etc. The display 500 can be used “Send” 540 a certificate to a holder or “Remove” 550 a holder from the list 530. Since the list 530 may contain a substantial number of prior certificate holders, a search option 520 may let the user quickly find a holder of interest. For example, FIG. 6 is a search result display 600 in accordance with some embodiments. Since “Mary” was entered into the search option 620, the search result list 630 was automatically updated.

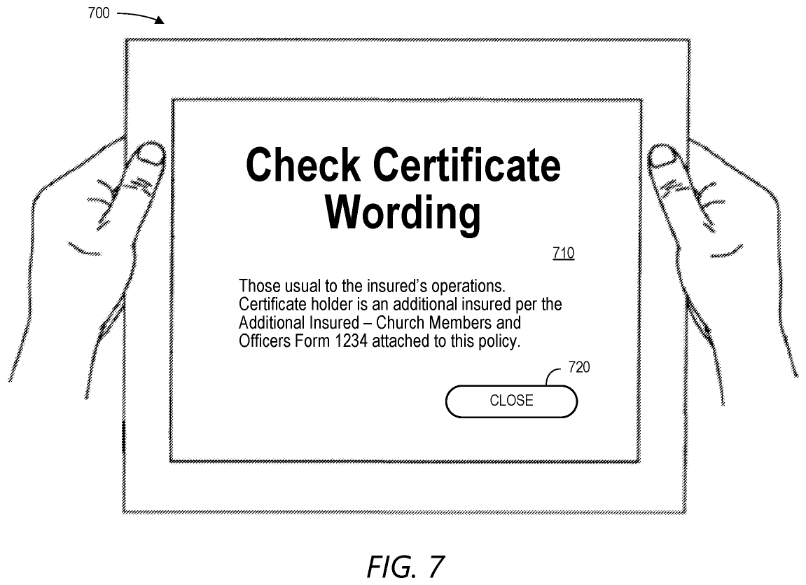

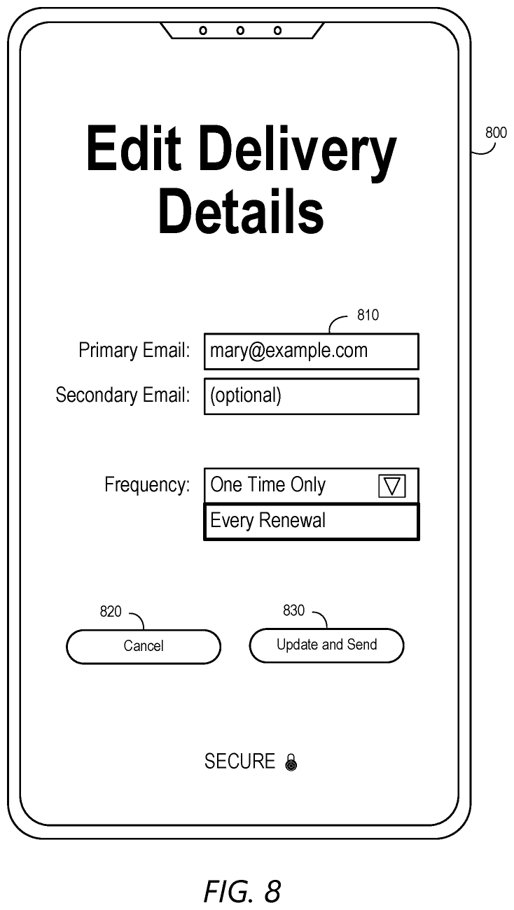

Note that devices other than a desktop or laptop computer may be used to provide document information. For example, FIG. 7 is a supplemental information display 710 shown on a tablet computer 700 according to some embodiments. The display 710 may let a user check any specific wording that has previously requested for that certificate holder and close 720 the display when finished. Similarly, FIG. 8 is a document delivery details display on a smartphone 800 in accordance with some embodiments that can be used to enter one or more communication addresses 810, define a request frequency (e.g., a one-time request or upon each policy renewal), cancel 820 an operation, or update and send 830 in accordance with the information provided.

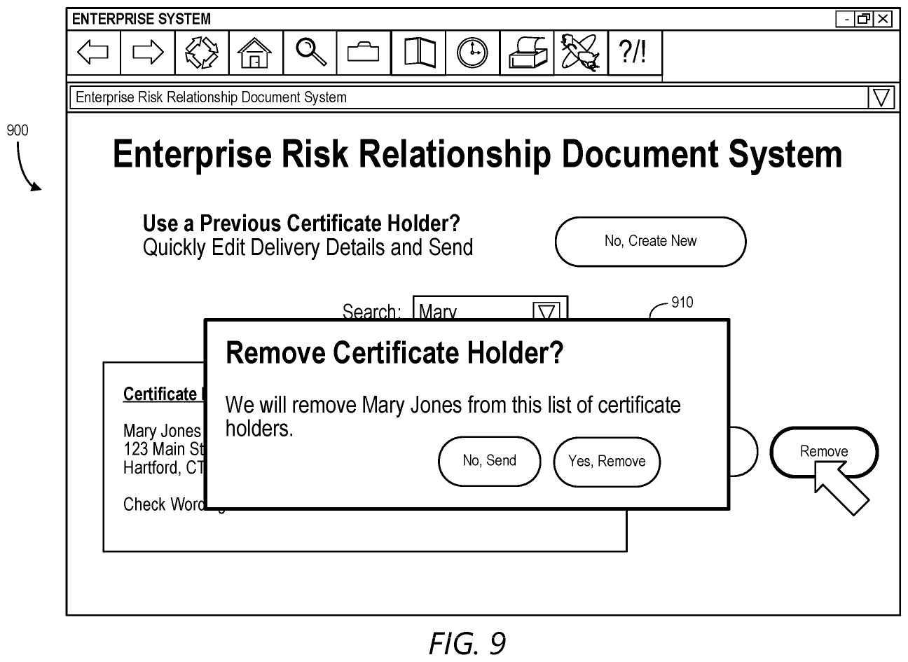

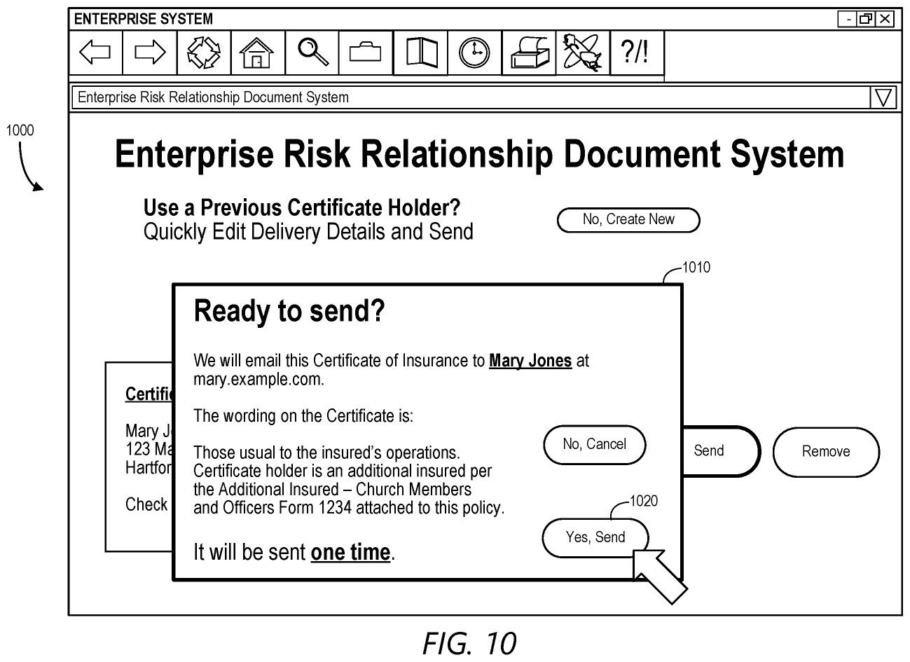

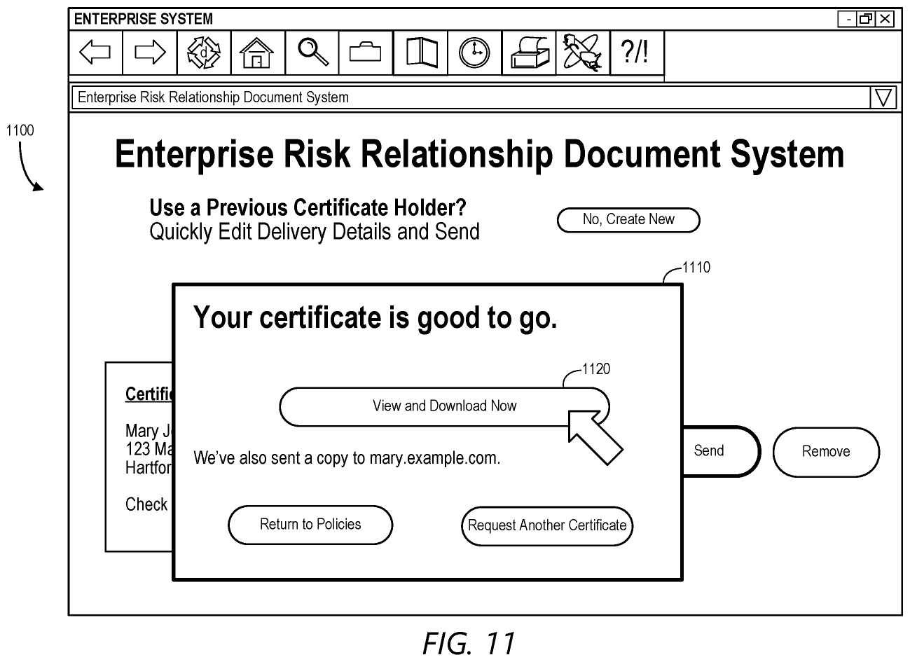

FIG. 9 is a certificate holder removal display 900 according to some embodiments. For example, if a user had selected to “Remove” 550 a holder from the list 530 in the prior certificate holders display 500, the removal display 900 may provide a popup window 910 to confirm that decision. Similarly, if a user had selected to “Send” 540 a certificate to a holder from the list 530 in the prior certificate holders display 500, a certificate transmission display 1000 such as the one illustrated in FIG. 10 may provide a popup window 1010 to confirm that decision and “Send” 1020 the certificate. In that case, FIG. 11 is a transmission confirmation display 1100 with a popup window 1110 that lets a user download a copy 1120 the certificate according to some embodiments.

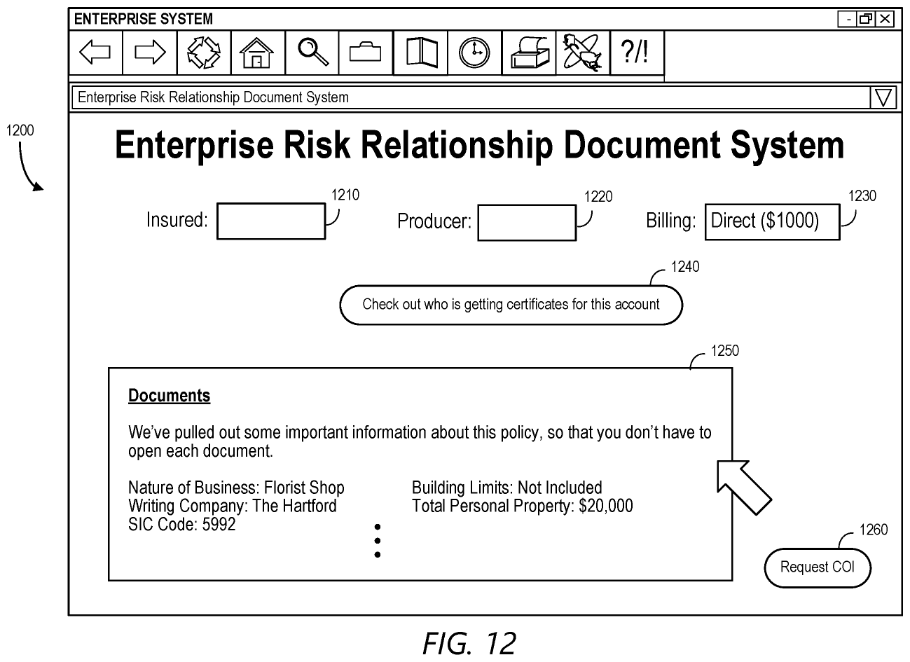

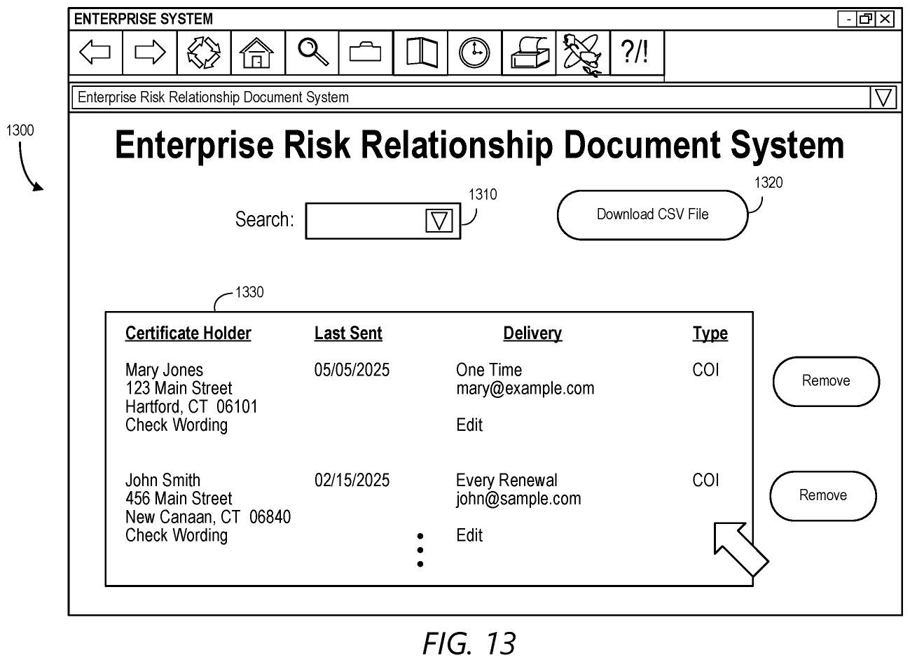

FIG. 12 is an insurance agency display 1200 in accordance with some embodiments. The agency display 1200 may provide information about one or more accounts of the agent such as the insured 1210, the producer 1220, and billing information 1230. The display 1200 may also let the agent determine who is receiving certificates for that account 1240 and extract key information from multiple insurance for convenient presentation 1250 to the agent. The display 1200 also lets the agent “Request a COI” 1260. FIG. 13 is another certificate holders display 1300 according to some embodiments that lets a user search 1310 for particular types of accounts and “Download a Comma Separated Values (“CSV”) File” 1320 containing the results 1330 of that search 1310 (e.g., for use with a MICROSOFT™ EXCEL® spreadsheet application).

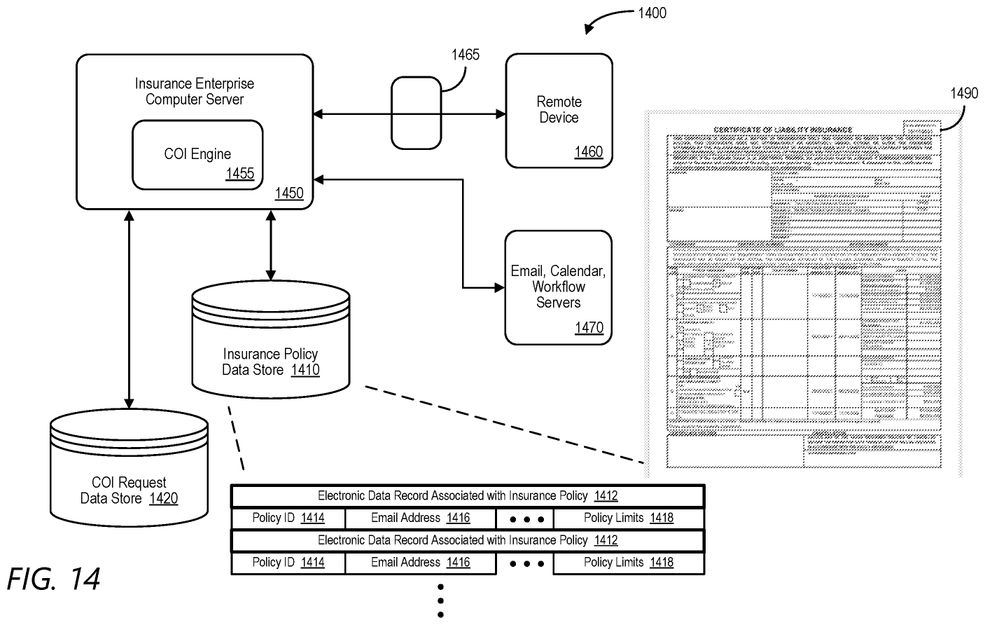

FIG. 14 is a more detailed system 1400 according to some embodiments. As before, the system 1400 includes an insurance enterprise computer server 1450 that may access information in an insurance policy data store 1410 (e.g., storing a set of electronic records associated with insurance policies 1412 including a policy identifier 1414, an email address 1416, policy limits 1418, etc.) and COI request data store 1420. The insurance enterprise computer server 1450 may also utilize a COI engine 1455 to exchange and process certificates and view, analyze, and/or update the electronic records. The insurance enterprise computer server 1450 may also exchange information with a remote device 1460 (e.g., via a firewall 1465). According to some embodiments, the back-end application computer server 1450 may automatically generate a COI 1490 and interact with an email server (e.g., to automatically establish communication links and/or transmit electronic messages), a calendar server (e.g., to automatically schedule tasks or communications based COI requests), and/or a workflow server 1470 (e.g., to initiate actions by employees or programs of the enterprise).

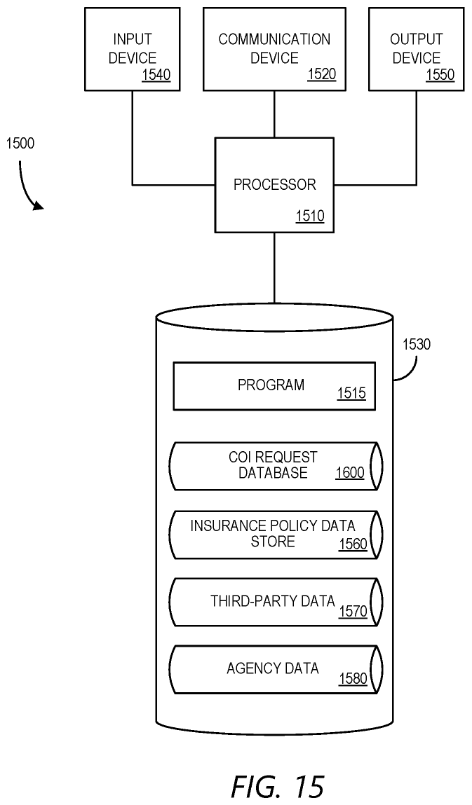

The embodiments described herein may be implemented using any number of different hardware configurations. For example, FIG. 15 illustrates an apparatus 1500 that may be, for example, associated with the systems 2, 14 described with respect to FIGS. 2 and 14, respectively (or any other system described herein). The apparatus 1500 comprises a processor 1510, such as one or more commercially available Central Processing Units (“CPUs”) in the form of one-chip microprocessors, coupled to a communication device 1520 configured to communicate via a communication network (not shown in FIG. 15). The communication device 1520 may be used to communicate, for example, with one or more remote third-party devices, agent devices, web-based tools, administrators, enterprise employees, and/or communication devices (e.g., PCs and smartphones). Note that communications exchanged via the communication device 1520 may utilize security features, such as those between a public internet user and an internal network of an insurance company and/or an enterprise. The security features might be associated with, for example, web servers, firewalls, and/or PCI infrastructure. The apparatus 1500 further includes an input device 1540 (e.g., a mouse and/or keyboard to enter information about COI searches, enterprise risk relationship document rules or preferences, communication addresses, etc.) and an output device 1550 (e.g., to output reports regarding enterprise risk relationship documents, recommendations, alerts, etc.).

The processor 1510 also communicates with a storage device 1530. The storage device 1530 may comprise any appropriate information storage device, including combinations of magnetic storage devices (e.g., a hard disk drive), optical storage devices, mobile telephones, and/or semiconductor memory devices. The storage device 1530 stores a program 1515 and/or an enterprise risk relationship document tool or application for controlling the processor 1510. The processor 1510 performs instructions of the program 1515, and thereby operates in accordance with any of the embodiments described herein. For example, the processor 1510 may receive a risk relationship document request associated with a particular risk relationship identifier. Responsive to the risk relationship document request, the processor 1510 may retrieve information, and (based on the retrieved information) a risk relationship document may be automatically created. The processor 1510 may automatically establish a communication link and transmit information about the risk relationship document to the communication address associated with the particular risk relationship identifier. The processor 1510 may also exchange data with a remote device to support interactive user interface displays that include information about the risk relationship document.

The program 1515 may be stored in a compressed, uncompiled and/or encrypted format. The program 1515 may furthermore include other program elements, such as an operating system, a database management system, and/or device drivers used by the processor 1510 to interface with peripheral devices.

As used herein, information may be “received” by or “transmitted” to, for example: (i) the apparatus 1500 from another device; or (ii) a software application or module within the apparatus 1500 from another software application, module, or any other source.

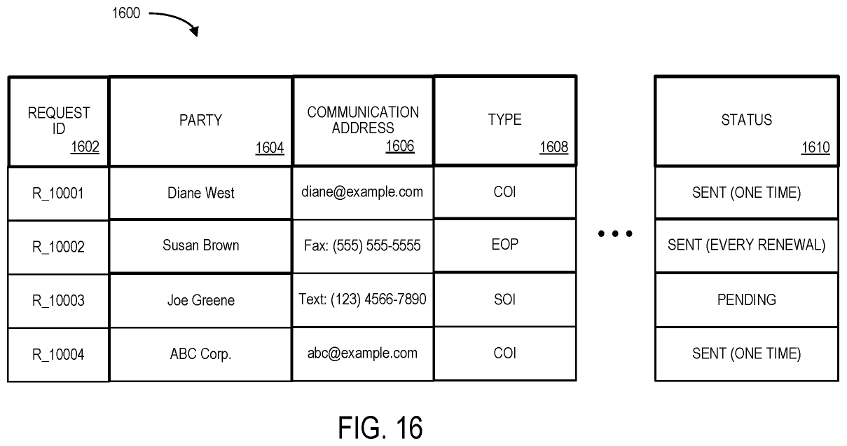

In some embodiments (such as shown in FIG. 15), the storage device 1530 further includes COI request database 1600, an insurance policy data store 1560, third-party data 1570, and agency data 1580. An example of a database that might be used in connection with the apparatus 1500 will now be described in detail with respect to FIG. 16. Note that the database described herein is only an example, and additional and/or different information may be stored therein. Moreover, various databases might be split or combined in accordance with any of the embodiments described herein. For example, the insurance policy data store 1560 and third-party data 1570 might be combined and/or linked to each other within the program 1515.

Referring to FIG. 16, a table is shown that represents the COI request database 1600 that may be stored at the apparatus 1500 according to some embodiments. The table may include, for example, entries associated with different COI requests that have been provided to an enterprise. The table may also define fields 1602, 1604, 1606, 1608, 1610 for each of the entries. The fields 1602, 1604, 1606, 1608, 1610 may, according to some embodiments, specify: a request identifier 1602, a party 1604, a communication address 1606, a type 1608, and a status 1610. The COI request database 1600 may be created and updated, for example, when a new request is created or an existing request is updated in connection with an insurer or business.

The request identifier 1602 may be, for example, a unique alphanumeric code identifying a request for proof of insurance. The party 1604 might indicate who request a COI (or show should receive it) and the communication address 1606 may define how that COI should be sent. The type 1608 may indicate a specific type of proof of insurance (COI, EOP, SOI, a NY specific form, etc.). The status 1610 might indicate that the request has received a response, is currently pending, etc.

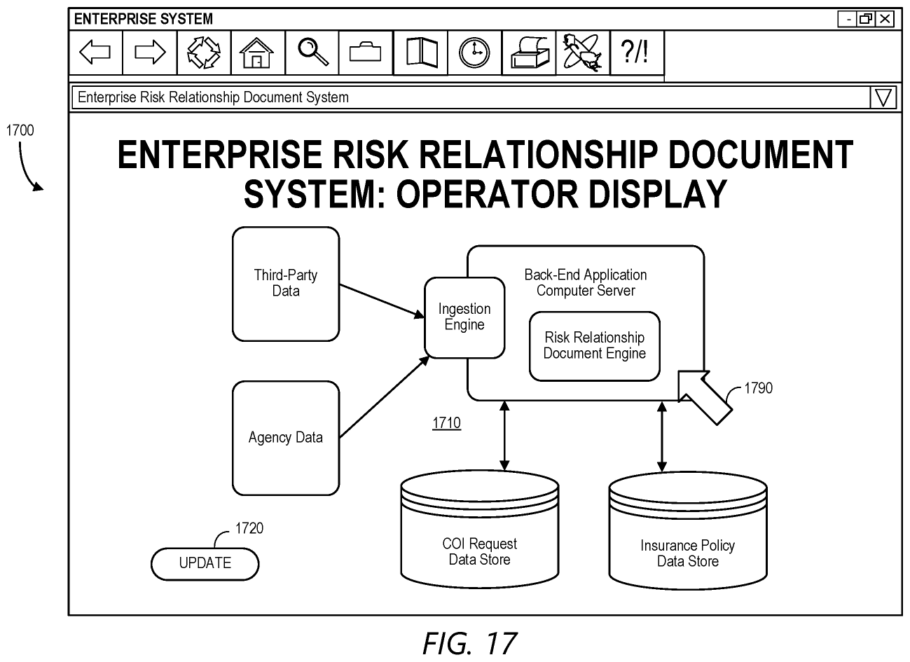

The operation of the enterprise risk relationship document system may be controlled via a Graphical User Interface (“GUI”). For example, FIG. 17 is an enterprise risk relationship document operator or administrator display 1700 including graphical representations of elements of such a tool 1710 according to some embodiments. Selection of a portion or element of the display 1700 via a touchscreen or pointer 1790 might result in the presentation of additional information about that portion or element (e.g., a popup window presenting data mappings, security request details, etc.) or let an operator or administrator enter or annotate additional information about a COI (e.g., based on his or her experience and expertise). An “Update” icon 1720 might initiate an enterprise risk relationship document process.

Thus, embodiments may let a user issue a COI or EOP for an existing recipient with no updates to the recipient's name, address, and/or specific wording. Moreover, the user can easily update a recipient's email and deactivate recipients that are no longer required. Agents and customers can view a list of account recipients that are currently active and downloadable a CSV file with recipient information for those active on the agent's account. Such an approach may reduce costs, allow for the quicker turn-around of information, provide an improved experience for the customer and/or agent, reduce environmental impact (e.g., by reducing paperwork and message transmission), etc.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of insurance, embodiments may instead be associated with other types of insurance in addition to and/or instead of those described herein. Similarly, although certain types of insurance, businesses, and organization parameters were described in connection some embodiments herein, other types of arrangements and configurations might be used instead.

In some embodiments, a user may manually select one or more certificate holders to receive a risk relationship document (e.g., by selecting the “Send” icon 540 as described in connection with FIG. 5. In other embodiments, third-party data 230 and a machine learning model may be used by the system to automatically determine a set of certificate holders (e.g., based on clients or contracts associated with a particular insured). As used herein, the phrase “machine learning model” may refer to any artificial intelligence algorithm. The risk relationship document may then be transmitted to each certificate holder and any adjustment to the automatically determined set (e.g., if a user removes one of the certificate holders) can then be provided as feedback to the machine learning model (e.g., to improve future performance of the model).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. An enterprise risk relationship document system implemented via a back-end application computer server of an enterprise, comprising:
(a) a risk relationship data store that contains electronic records associated with a plurality of risk relationships between the enterprise and parties, and, for each risk relationship, a risk relationship identifier, a party identifier, a communication address, and at least one risk relationship parameter;
(b) the back-end application computer server, coupled to the risk relationship data store, including:
a computer processor, and
a computer memory coupled to the computer processor and storing instructions that, when executed by the computer processor, cause the back-end application computer server to:
receive a risk relationship document request associated with a particular risk relationship identifier,
responsive to the risk relationship document request, retrieve information from the risk relationship data store,
based on the retrieved information, automatically create a risk relationship document, and
automatically establish a communication link and transmit information about the risk relationship document to the communication address associated with the particular risk relationship identifier; and
(c) a communication port coupled to the back-end application computer server to facilitate an exchange of data with a remote device via a distributed communication network to support interactive user interface displays that include information about the risk relationship document.

2. The system of claim 1, wherein the communication address is associated with at least one of: (i) an email address, (ii) a telephone number, (iii) a Quick Response (“QR”) code, (iv) a username and password, (v) a chat interface, (vi) an Interactive Voice Response (“IVR”) system, and (vii) a mobile smartphone application.

3. The system of claim 1, wherein the enterprise is an insurer, the risk relationships are associated with insurance policies, and the parties are associated with insureds.

4. The system of claim 3, wherein the risk relationship document is associated with at least one of: (i) proof of insurance, (ii) a Certificate Of Insurance (“COI”), (iii) an Evidence Of Property (“EOP”), (iv) a Statement Of Insurance (“SOI”), and (v) a state-specific document.

5. The system of claim 4, wherein a plurality of risk relationship documents of different types are created and transmitted.

6. The system of claim 3, wherein at least one risk relationship parameter is associated with at least one of: (i) a producer, (ii) a type of insurance, (iii) a coverage limit, (iv) a policy period, and (v) a certificate holder.

7. The system of claim 3, wherein the risk relationship document request is received from at least one of: (i) an insured, and (ii) an insurance agent.

8. The system of claim 3, wherein the interactive user interface displays are further to let a requestor reuse information from a prior risk relationship document request.

9. The system of claim 3, wherein the interactive user interface displays are further to display at least one of: (i) information about a plurality of insureds, and (ii) information about a plurality of insurance policies.

10. The system of claim 9, wherein the interactive user interface displays are further to perform a search associated with the plurality of insureds or insurance policies.

11. The system of claim 3, wherein the interactive user interface displays are further to let a requestor schedule or cancel future risk relationship document requests.

12. They system of claim 3, wherein the back-end application computer server is further to:
automatically determine a set of certificate holders based on a machine learning model and third party-data, wherein the risk relationship document is transmitted to each certificate holder and any adjustment to the automatically determined set is provided as feedback to the machine learning model.

13. An enterprise risk relationship document method implemented via a back-end application computer server of an enterprise, comprising:
receiving, at a computer processor of the back-end application computer server, a risk relationship document request associated with a particular risk relationship identifier;
responsive to the risk relationship document request, retrieving information from a risk relationship data store, wherein the risk relationship data store contains electronic records associated with a plurality of risk relationships between the enterprise and parties, and, for each risk relationship, a risk relationship identifier, a party identifier, a communication address, and at least one risk relationship parameter;
based on the retrieved information, automatically creating a risk relationship document;
automatically establishing a communication link and transmitting information about the risk relationship document to the communication address associated with the particular risk relationship identifier; and
exchanging data with a remote device via a distributed communication network to support interactive user interface displays that include information about the risk relationship document.

14. The method of claim 13, wherein the communication address is associated with at least one of: (i) an email address, (ii) a telephone number, (iii) a Quick Response (“QR”) code, (iv) a username and password, (v) a chat interface, (vi) an Interactive Voice Response (“IVR”) system, and (vii) a mobile smartphone application.

15. The method of claim 13, wherein the enterprise is an insurer, the risk relationships are associated with insurance policies, and the parties are associated with insureds.

16. The method of claim 15, wherein the risk relationship document is associated with at least one of: (i) proof of insurance, (ii) a Certificate Of Insurance (“COI”), (iii) an Evidence Of Property (“EOP”), (iv) a Statement Of Insurance (“SOI”), and (v) a state-specific document.

17. The method of claim 16, wherein a plurality of risk relationship documents of different types are created and transmitted.

18. A non-transitory, computer-readable medium storing instructions, that, when executed by a processor, cause the processor to perform an enterprise risk relationship document method implemented via a back-end application computer server of an enterprise, the method comprising:
receiving, at a computer processor of the back-end application computer server, a risk relationship document request associated with a particular risk relationship identifier;
responsive to the risk relationship document request, retrieving information from a risk relationship data store, wherein the risk relationship data store contains electronic records associated with a plurality of risk relationships between the enterprise and parties, and, for each risk relationship, a risk relationship identifier, a party identifier, a communication address, and at least one risk relationship parameter;
based on the retrieved information, automatically creating a risk relationship document;
automatically establishing a communication link and transmitting information about the risk relationship document to the communication address associated with the particular risk relationship identifier; and
exchanging data with a remote device via a distributed communication network to support interactive user interface displays that include information about the risk relationship document.

19. The medium of claim 18, wherein the communication address is associated with at least one of: (i) an email address, (ii) a telephone number, (iii) a Quick Response (“QR”) code, (iv) a username and password, (v) a chat interface, (vi) an Interactive Voice Response (“IVR”) system, and (vii) a mobile smartphone application.

20. The medium of claim 18, wherein the enterprise is an insurer, the risk relationships are associated with insurance policies, and the parties are associated with insureds.

21. The medium of claim 20e, wherein at least one risk relationship parameter is associated with at least one of: (i) a producer, (ii) a type of insurance, (iii) a coverage limit, (iv) a policy period, and (v) a certificate holder.

22. The medium of claim 20, wherein the risk relationship document request is received from at least one of: (i) an insured, and (ii) an insurance agent.
